(19) United States
(12) Patent Application Publication
(10) Pub. No.: US 2017/0180330 A1
(43) Pub. Date: Jun. 22, 2017

(54) METHOD AND ELECTRONIC DEVICE FOR VEHICLE REMOTE CONTROL AND A NON-TRANSITORY COMPUTER READABLE STORAGE MEDIUM

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Kai SU, Tianjin (CN); Libiao WANG, Tianjin (CN); Yifei CHEN, Tianjin (CN)

(21) Appl. No.: 15/236,857

(22) Filed: Aug. 15, 2016

Related U.S. Application Data
(63) Continuation of application No. PCT/CN2016/088448, filed on Jul. 4, 2016.

(30) Foreign Application Priority Data
Dec. 18, 2015 (CN) 2015109648086

(51) Int. Cl. H04L 29/06; G05D 1/00; H04W 12/08; H04L 29/08; H04L 9/08

(52) U.S. Cl. CPC H04L 63/0428; H04L 67/12; H04L 63/0272; H04L 9/0891; H04L 63/101; H04W 12/08; G05D 1/0022; G05D 1/0088; H04W 4/14

(57) ABSTRACT

Disclosed are an method and electronic device for vehicle remote control and a non-transitory computer readable storage medium includes: receiving an encrypted remote control instruction sent by a server through a pre-established encrypted network connection with the server, the remote control instruction being sent to the server by a user terminal; decrypting the received encrypted remote control instruction, and successively verifying the validity, legality and rationality of the decrypted remote control instruction; executing the remote control instruction when all the validity, legality and rationality pass the verification; and, sending a result of instruction execution to the server through the encrypted network connection after the remote control instruction has been executed.

### CROSS REFERENCE TO RELATED APPLICATIONS

This application is a continuation of PCT application No. PCT/CN2016/088448 filed on Jul. 4, 2016, which is based upon and claims the priority to Chinese patent application No. 201510964808.6, filed on Dec. 18, 2015 and entitled “VEHICLE REMOTE CONTROL METHOD, DEVICE AND SYSTEM”, the entire contents of which are hereby incorporated by reference.

### TECHNICAL FIELD

The present disclosure relates the technical field of car networking, and in particular, to a method and electronic device for vehicle remote control and a non-transitory computer readable storage medium.

### BACKGROUND

The arrival of the mobile internet era and the popularization of mobile terminals such as smart phones make consumer electronic intelligent technologies gradually introduced and used in the automotive field, such that the rapid development of auto intelligence and information is promoted, the intelligence level of automobiles is improved and the demands of automobile consumers for intelligence are met. The realization of vehicle remote control is the first step, as well as a key step, of the development of intelligent automobiles.

The function of an automobile remote control system is to make owners more conveniently and intelligently control automobiles. The system can complete majority of functions only through an intelligent terminal such as a mobile phone, such that an owner may control a vehicle any time and any place without limits, thereby really realizing the organic combination of the person and the vehicle.

The arrival of the mobile internet era and the popularization of mobile terminals such as smart phones make consumer electronic intelligent technologies gradually introduced and used in the automotive field, such that the rapid development of auto intelligence and information is promoted, the intelligence level of automobiles is improved and the demands of automobile consumers for intelligence are met. The realization of vehicle remote control is the first step, as well as a key step, of the development of intelligent automobiles.

The function of an automobile remote control system is to make owners more conveniently and intelligently control automobiles. The system can complete majority of functions only through an intelligent terminal such as a mobile phone, such that an owner may control a vehicle any time and any place without limits, thereby really realizing the organic combination of the person and the vehicle.

Considering the stability of signals and the standby power consumption, existing automobile remote control solutions all employ a vehicle remote control technology based on SMS (Short Message Service), and establish a remote control system by a method of combining SMS/MMS (Multimedia Messaging Service) with a CAN bus technology in an automobile, such that an owner may control the terminal by sending a short message by a mobile phone, so as to realize remote control.

However, at present, there are following problems when the vehicle remote control is performed using the SMS technology: on one hand, during the transmission process, due to low security, the content of a short message is likely to be intercepted and duplicated, which will cause a great potential security risk for vehicles, so the interception of short messages, simulated transmitting from a pseudo base station, the duplication of short messages and the like will influence the security of vehicles; meanwhile, the data transmission delay of a short message channel will also influence the timeliness of the remote control, or even a potential safety hazard will be caused due to the reception of short messages at wrong time.

### SUMMARY

To solve the technical problems of poor security and timeliness when the remote control is performed for a vehicle using the SMS technology in the prior art, the present disclosure provides a method and electronic device for vehicle remote control and a non-transitory computer readable storage medium.

In the first aspect, an embodiment of the present disclosure provides a vehicle remote control method, including the following steps of:

receiving an encrypted remote control instruction sent by a server through a pre-established encrypted network connection with the server, the remote control instruction being sent to the server by a user terminal;

decrypting the received encrypted remote control instruction, and successively verifying the validity, legality and rationality of the decrypted remote control instruction;

executing the remote control instruction when all the validity, legality and rationality pass the verification; and

sending an instruction execution result to the server through the encrypted network connection after the remote control instruction has been executed.

Optionally, before receiving an encrypted remote control instruction sent by a server through a pre-established encrypted network connection with the server, the method further includes:

connecting to a server through a mobile communication network; and

establishing an encrypted network connection with the server through encryption security authentication and key updating.

Optionally, before receiving an encrypted remote control instruction sent by a server through a pre-established encrypted network connection with the server, the method further includes:

connecting to a server through a Virtual Private Network (VPN), and establishing an encrypted private network connection with the server.

Optionally, the decrypting the received encrypted remote control instruction and successively verifying the validity, legality and rationality of the encrypted remote control instruction includes:

decrypting the received encrypted remote control instruction, verifying the validity of the remote control instruction to check whether the remote control instruction is sent to this vehicle or not, indicating that validity passes the verification if the remote control instruction is sent to this vehicle, and indicating that validity does not pass the verification if the remote control instruction is not sent to this vehicle;

verifying the legality of the remote control instruction to determine whether the remote control instruction belongs to an instruction white-list or not, indicating that the legality passes the verification if the remote control instruction belongs to the instruction white-list, and indicating that the legality does not pass the verification if the remote control instruction does not belong to the instruction white-list; and

verifying the rationality of the remote control instruction to determine whether the content of the remote control instruction meets a preset rational execution condition or not, indicating that the rationality passes the verification if the content of the remote control instruction meets the preset rational execution condition, and indicating that the rationality does not pass the verification if the content of the remote control instruction does not meet the preset rational execution condition.

Optionally, executing the remote control instruction when all the validity, legality and rationality pass the verification includes:

determining, according to the content of the remote control instruction, whether the remote control instruction is executed by the vehicle-mounted remote control electronic device or a vehicle intelligent operating system;

directly executing the remote control instruction when the remote control instruction is executed by the vehicle-mounted remote control electronic device;

and

awakening the vehicle intelligent operating system to execute the remote control instruction when the remote control instruction is executed by the vehicle intelligent operating system.

According to the vehicle remote control method provided by the present disclosure, by communicating a vehicle-mounted remote control electronic device with a server in an encrypted network connection manner, the secure reliability of the remote control instruction during the transmission process is ensured, the transmission speed of the remote control instruction is greatly improved, and the security of a user's vehicle and the timeliness of executing the remote control instruction are ensured. Accordingly, compared with the prior art, the present disclosure provides better user experience effects.

In the second aspect, an embodiment of the present disclosure provides a vehicle-mounted remote control electronic device, including: processor memory, a communication interface and at least one processor, wherein the memory is configured to store program codes, and the at least one processor reads the program codes stored in the memory and executes the following steps of: receiving an encrypted remote control instruction sent by a server through a pre-established encrypted network connection with the server, the remote control instruction being sent to the server by a user terminal; decrypting the received encrypted remote control instruction, and successively verifying the validity, legality and rationality of the decrypted remote control instruction; executing the remote control instruction when all the validity, legality and rationality pass the verification; and, sending an instruction execution result to the server through the encrypted network connection after the remote control instruction has been executed.

In one possible implementation, before receiving an encrypted remote control instruction sent by a server through a pre-established encrypted network connection with the server, the processor executes the following steps of: connecting to a server through a mobile communication network; and, establishing an encrypted network connection with the server through encryption security authentication and key updating.

In one possible implementation, before receiving an encrypted remote control instruction sent by a server through a pre-established encrypted network connection with the server, the processor executes the following steps of: connecting to a server through a Virtual Private Network (VPN), and establishing an encrypted private network connection with the server.

In one possible implementation, the processor executes the following steps of: decrypting the received encrypted remote control instruction, verifying the validity of the remote control instruction to check whether the remote control instruction is sent to this vehicle or not, indicating that the validity passes the verification if the remote control instruction is sent to this vehicle, and indicating that the validity does not pass the verification if the remote control instruction is not sent to this vehicle; verifying the legality of the remote control instruction to determine whether the remote control instruction belongs to an instruction white-list or not, indicating that the legality passes the verification if the remote control instruction belongs to the instruction white-list, and indicating that the legality does not pass the verification if the remote control instruction does not belong to the instruction white-list; and, verifying the rationality of the remote control instruction to determine whether the content of the remote control instruction meets a preset rational execution condition or not, indicating that the rationality passes the verification if the content of the remote control instruction meets the preset rational execution condition, and indicating that the rationality does not pass the verification if the content of the remote control instruction does not meet the preset rational execution condition.

In one possible implementation, the processor executes the following steps of: determining, according to the content of the remote control instruction, whether the remote control instruction is executed by the vehicle-mounted remote control electronic device or a vehicle-mounted intelligent operating system; directly executing the remote control instruction when the remote control instruction is executed by the vehicle-mounted remote control electronic device; and, awakening the vehicle intelligent operating system to execute the remote control instruction when the remote control instruction is executed by the vehicle intelligent operating system.

In the third aspect, an embodiment of the present disclosure provides a non-transitory computer-readable storage medium having computer-executable instructions stored thereon, the computer-executable instructions being set to: receive an encrypted remote control instruction sent by a server through a pre-established encrypted network connection with the server, the remote control instruction being sent to the server by a user terminal; decrypt the received encrypted remote control instruction, and successively verify the validity, legality and rationality of the decrypted remote control instruction; execute the remote control instruction when all the validity, legality and rationality pass the verification; and, send an instruction execution result to the server through the encrypted network connection after the remote control instruction has been executed.

In one possible implementation, the computer-executable instructions are set to: before receiving an encrypted remote control instruction sent by a server through a pre-established encrypted network connection with the server, connect to a server through a mobile communication network; and, establish an encrypted network connection with the server through encryption security authentication and key updating.

In one possible implementation, the computer-executable instructions are set to: before receiving an encrypted remote control instruction sent by a server through a pre-established encrypted network connection with the server, connect to a server through a Virtual Private Network (VPN), and establish an encrypted private network connection with the server.

In one possible implementation, the computer-executable instructions are set to: decrypt the received encrypted remote control instruction, verify the validity of the remote control instruction to check whether the remote control instruction is sent to this vehicle or not, indicate that the validity passes the verification if the remote control instruction is sent to this vehicle, and indicate that the validity does not pass the verification if the remote control instruction is not sent to this vehicle; verify the legality of the remote control instruction to determine whether the remote control instruction belongs to an instruction white-list or not, indicate that the legality passes the verification if the remote control instruction belongs to the instruction white-list, and indicate that the legality does not pass the verification if the remote control instruction does not belong to the instruction white-list; and, verify the rationality of the remote control instruction to determine whether content of the remote control instruction meets a preset rational execution condition or not, indicate that the rationality passes the verification if the content of the remote control instruction meets the preset rational execution condition, and indicate that the rationality does not pass the verification if the content of the remote control instruction does not meet the preset rational execution condition.

In one possible implementation, the computer-executable instructions are set to: determine, according to the content of the remote control instruction, whether the remote control instruction is executed by the vehicle-mounted remote control electronic device or a vehicle-mounted intelligent operating system; directly execute the remote control instruction when the remote control instruction is executed by the vehicle-mounted remote control electronic device; and, awaken the vehicle intelligent operating system to execute the remote control instruction when the remote control instruction is executed by the vehicle intelligent operating system.

Other features and advantages of the present disclosure will be explained in the subsequent description, and partially become apparent from the description or are understood by implementing the present disclosure. The objectives and other advantages of the present disclosure may be realized and obtained by structures specified in the description, the appended claims and the drawings.

The technical solutions of the present disclosure will be further described in detail below in conjunction with the drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method according to some embodiments of the present disclosure;

FIG. 2 is a flowchart of a method according to some embodiments of the present disclosure;

FIG. 3 is a schematic diagram of the structure of a vehicle-mounted remote control electronic device according to some embodiments of the present disclosure;

FIG. 4 is a schematic diagram of the structure of another vehicle-mounted remote control electronic device according to some embodiments of the present disclosure; and

FIG. 5 is a schematic diagram of the structure of a vehicle-mounted remote control electronic device according to some embodiments of the present disclosure.

### DETAILED DESCRIPTION

The preferred embodiments of the present disclosure will be illustrated below in conjunction with the drawings. It should be appreciated that the preferred embodiments described herein are merely used for illustrating and explaining the present disclosure, rather than limiting it.

### Embodiment 1

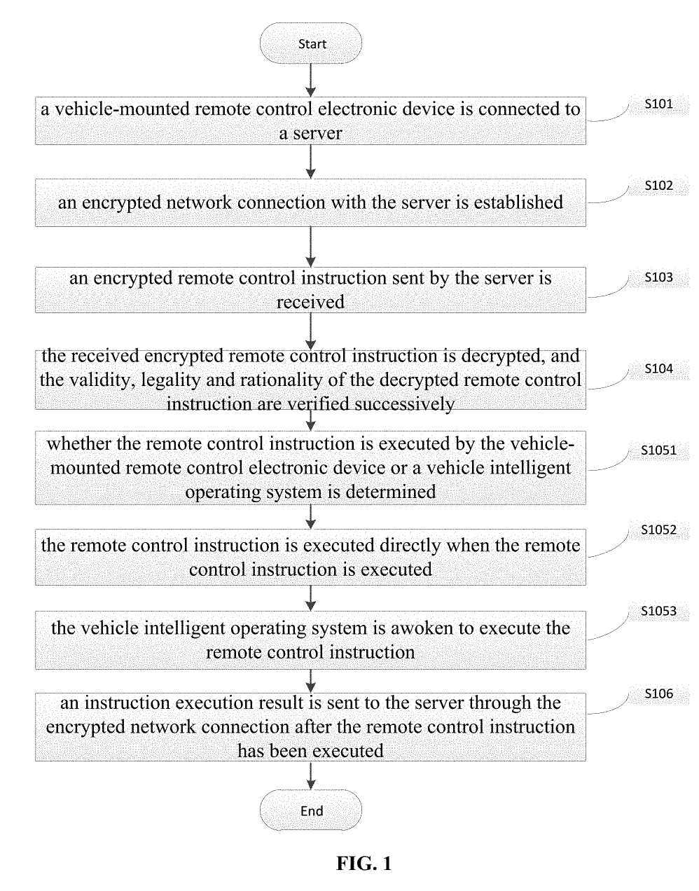

As shown in FIG. 1, the present disclosure provides a vehicle remote control method, including the following steps.

Step S101: a vehicle-mounted remote control electronic device is connected to a server through a mobile communication network.

In some embodiments, a mobile communication network connection mode is employed between the vehicle-mounted remote control electronic device and the server. It should be understood by those skilled in the art that, to ensure security and timeliness, any network connection mode capable of realizing data security and real-time transmission may be used in the embodiments of the present disclosure.

The mobile network connection in some embodiments is merely for specifically describing the method provided by the present disclosure, rather than limiting the protection scope of the present disclosure.

Step S102: an encrypted network connection with the server is established through encryption security authentication and key updating.

In this step, the establishment mode of the encrypted network connection may be any establishment mode of the encrypted network connection in the prior art and will not be repeated here.

Preferably, steps S101 and S102 may be replaced with the following steps of: connecting to a server through a Virtual Private Network (VPN), and establishing an encrypted private network connection with the server.

As a private network established on a public network, the Virtual Private Network (VPN) is used for encrypted communication and widely applied to the enterprise network. A VPN gateway realizes remote access by encrypting a data packet and converting a target address of the data packet.

Step S103: an encrypted remote control instruction sent by the server is received through the pre-established encrypted network connection with the server, the remote control instruction being sent to the server by a user terminal.

Since the encrypted network connection is employed in some embodiments in order to ensure the security of data transmission, the server will encrypt the instruction before sending the remote control instruction received from the user terminal (may be a smart phone or the like) to a vehicle-mounted remote control electronic device, so as to ensure the security of the instruction during the transmission process.

Both the server and the vehicle-mounted remote control electronic device are stored with the same encryption/decryption algorithms and keys in advance, such that the encrypted instruction can be decrypted successfully.

More preferably, upon receiving the remote control instruction sent by user A for vehicle X, the server will also compare the identity of user A with the identity of a user to which vehicle X belongs. If the result of comparison is consistent, it is indicated that the control instruction is sent by a legal user (owner), then, the instruction is encrypted and then sent to the vehicle-mounted remote control electronic device. However, if the result of composition is inconsistent, it is indicated that the control instruction is not sent by a legal user (owner), and then the instruction will be rejected to be sent to the vehicle-mounted remote control electronic device.

Step S104: the received encrypted remote control instruction is decrypted, and the validity, legality and rationality of the decrypted remote control instruction are verified successively.

In some embodiments, upon receiving the remote control instruction and before executing the instruction content, the vehicle-mounted remote control electronic device first needs to verify the validity of the instruction, then determines the legality and rationality of the instruction, and then performs corresponding processing on different instruction contents after confirmation, such that it can be adequately ensured that a valid remote control instruction is executed under the rational and legal conditions.

Step S105: the remote control instruction is executed when all the validity, legality and rationality pass the verification.

After it is confirmed that the remote control instruction is valid, legal and rational, it is also required to determine, according to the content of the instruction, whether the instruction is executed directly by the vehicle-mounted remote control electronic device or executed by awakening a vehicle intelligent operating system. Here, the basic principle is as follows: the instruction is executed directly if the vehicle-mounted remote control electronic device can directly work out, while a vehicle intelligent operating system will be awakened and then the instruction is executed by the vehicle intelligent operating system if the instruction cannot be executed directly.

Step S105 may be specifically implemented as the following steps.

Step S1051: whether the remote control instruction is executed by the vehicle-mounted remote control electronic device or a vehicle intelligent operating system is determined according to the content of the remote control instruction.

S1052: the remote control instruction is executed directly when the remote control instruction is executed by the vehicle-mounted remote control electronic device.

S1053: the vehicle intelligent operating system is awoken to execute the remote control instruction when the remote control instruction is executed by the vehicle intelligent operating system.

In some embodiments, the instruction content which should be directly executed by the vehicle-mounted remote control electronic device includes: ignition, braking or other vehicle safe driving behaviors; while the instruction content which is executed by the vehicle intelligent operating system includes: activating the radio or other entertainment setting behaviors.

Step S106: an instruction execution result is sent to the server through the encrypted network connection after the remote control instruction has been executed.

The vehicle-mounted remote control electronic device feeds back the result of instruction execution to the server, such that the server timely knows the real-time operation state of the vehicle.

The method for vehicle remote control provided by the present disclosure, by communicating a vehicle-mounted remote control electronic device with a server in an encrypted network connection manner, the secure reliability of the remote control instruction during the transmission process is ensured, the transmission speed of the remote control instruction is greatly improved, and the security of a user's vehicle and the timeliness of executing the remote control instruction are ensured. Accordingly, compared with the prior art, the present disclosure provides better user experience effects.

### Embodiment 2

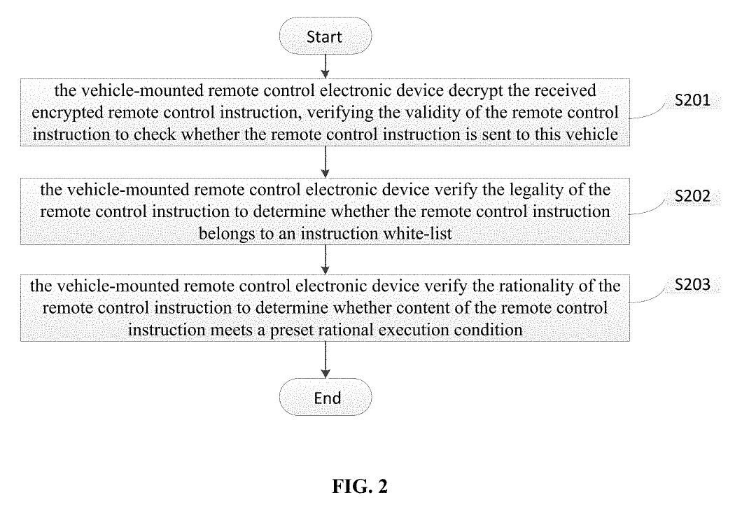

As shown in FIG. 2, step S104 in Embodiment 1 will be further described in detail and includes the following steps.

Step S201: the vehicle-mounted remote control electronic device decrypt the received encrypted remote control instruction, verifying the validity of the remote control instruction to check whether the remote control instruction is sent to this vehicle or not, indicating that the validity passes the verification if the remote control instruction is sent to this vehicle, and indicating that the validity does not pass the verification if the remote control instruction is not sent to this vehicle.

The vehicle-mounted remote control electronic device receives the encrypted remote control instruction, decrypts the remote control instruction, and determines the validity of the instruction to check whether the remote control instruction is sent to this vehicle or not. If it is confirmed that the instruction is sent to this vehicle, the instruction is valid; otherwise, the instruction is invalid.

S202: the vehicle-mounted remote control electronic device verify the legality of the remote control instruction to determine whether the remote control instruction belongs to an instruction white-list or not, indicating that the legality passes the verification if the remote control instruction belongs to the instruction white-list, and indicating that the legality does not pass the verification if the remote control instruction does not belong to the instruction white-list.

After the validity of the instruction passes the verification, whether the instruction content is legal is determined. A legal instruction refers to an instruction in an instruction white-list. If an instruction is not in the instruction white-list, the instruction is illegal and not allowed to be executed.

Step S203: the vehicle-mounted remote control electronic device verify the rationality of the remote control instruction to determine whether content of the remote control instruction meets a preset rational execution condition or not, indicating that the rationality passes the verification if the content of the remote control instruction meets the preset rational execution condition, and indicating that the rationality does not pass the verification if the content of the remote control instruction does not meet the preset rational execution condition.

After the legality of the instruction passes the verification, whether the instruction is rational is determined. The rationality means that, there are respective rational execution conditions according to different instruction contents and instructions meeting the conditions may be executed. Specifically, different instructions have different conditions, and the conditions needs to be determined separately. For example, if an instruction received by the vehicle-mounted remote control electronic device is braking, but the vehicle is running at a high speed at this time, as it is usually not allowed to brake freely on a highway, the vehicle-mounted remote control electronic device considers that the instruction is not rational. In other words, the rationality does not pass the verification, and the instruction is rejected to be executed.

Some embodiments further defines Embodiments and has all beneficial technical effects of Embodiment 1, and the beneficial technical effects will not be repeated here.

### Embodiment 3

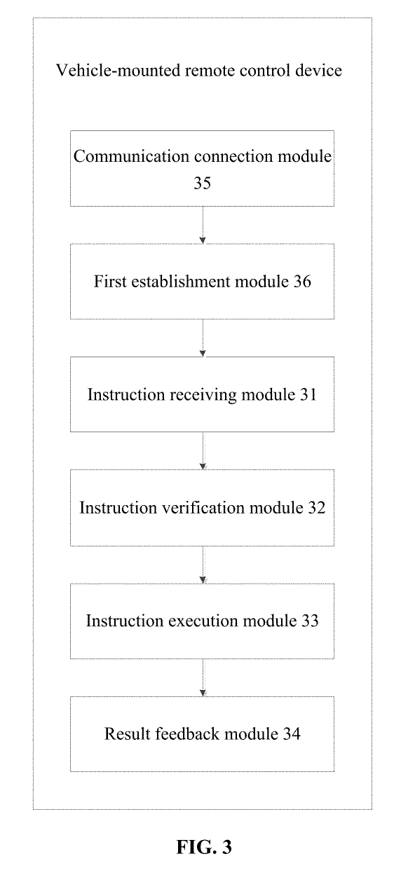

As shown in FIG. 3, the present disclosure provides a vehicle-mounted remote control electronic device, including:

an instruction receiving module 31, configured to receive an encrypted remote control instruction sent by a server through a pre-established encrypted network connection with the server, the remote control instruction being sent to the server by a user terminal;

an instruction verification module 32, configured to decrypt the received encrypted remote control instruction, and successively verify the validity, legality and rationality of the decrypted remote control instruction;

an instruction execution module 33, configured to execute the remote control instruction when all the validity, legality and rationality pass the verification; and

a result feedback module 34, configured to send an instruction execution result to the server through the encrypted network connection after the remote control instruction has been executed.

Preferably, the vehicle-mounted remote control electronic device further includes:

a communication connection module 35, configured to connect to a server through a mobile communication network; and

a first establishment module 36, configured to establish an encrypted network connection with the server through encryption security authentication and key updating.

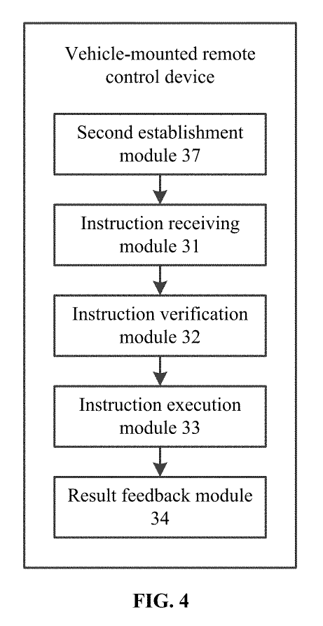

Preferably, in another embodiment, as shown in FIG. 4, the communication connection module 35 and the first establishment module 36 may be replaced with the following module:

a second establishment module 37, configured to connect to a server through a Virtual Private Network (VPN) and establish an encrypted private network connection with the server.

Preferably, the instruction verification module 32 is specifically configured to: decrypt the received encrypted remote control instruction, verify the validity of the remote control instruction to check whether the remote control instruction is sent to this vehicle or not, indicate that the validity passes the verification if the remote control instruction is sent to this vehicle, and indicate that the validity does not pass the verification if the remote control instruction is not sent to this vehicle;

verify the legality of the remote control instruction to determine whether the remote control instruction belongs to an instruction white-list or not, indicate that the legality passes the verification if the remote control instruction belongs to the instruction white-list, and indicate that the legality does not pass the verification if the remote control instruction does not belong to the instruction white-list; and

verify the rationality of the remote control instruction to determine whether the content of the remote control instruction meets a preset rational execution condition or not, indicate that the rationality passes the verification if the content of the remote control instruction meets the preset rational execution condition, and indicate that the rationality does not pass the verification if the content of the remote control instruction does not meet the preset rational execution condition.

Preferably, the instruction execution module 33 is specifically configured to: determine, according to the content of the remote control instruction, whether the remote control instruction is executed by the vehicle-mounted remote control electronic device or a vehicle-mounted intelligent operating system; directly execute the remote control instruction when the remote control instruction is executed by the vehicle-mounted remote control electronic device; and, awaken the vehicle intelligent operating system to execute the remote control instruction when the remote control instruction is executed by the vehicle intelligent operating system.

In the vehicle-mounted remote control electronic device provided by the present disclosure, by communicating with a server in an encrypted network connection manner, the secure reliability of the remote control instruction during the transmission process is ensured, the transmission speed of the remote control instruction is greatly improved, and the security of a user's vehicle and the timeliness of executing the remote control instruction are ensured. Accordingly, compared with the prior art, the present disclosure provides better user experience effects.

### Embodiment 4

The present disclosure further provides a vehicle remote control system, including a server and the vehicle-mounted remote control electronic device provided in Embodiment 3. The server receives a remote control instruction sent by a user terminal, then encrypts the remote control instruction, and sends the encrypted remote control instruction to the vehicle-mounted remote control electronic device through a pre-established encrypted network connection. The server also receives an instruction execution result, which is sent by the vehicle-mounted remote control electronic device through the encrypted network connection.

### Embodiment 5

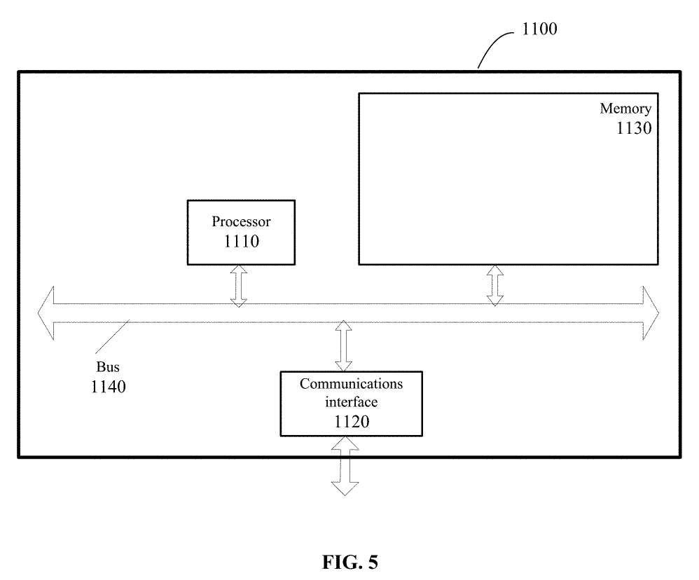

FIG. 5 shows a block diagram of the structure of a vehicle-mounted remote control electronic device according to another embodiment of the present disclosure. The vehicle-mounted remote control electronic device 1100 may be a host server having computing capability, a personal computer (PC), a carriable portable computer or terminal, or the like. The specific implementation of a computing node is not limited by the specific embodiments of the present disclosure.

The vehicle-mounted remote control electronic device 1100 includes at least one processor 1110 (taking one processor 1110 as example in FIG. 5), a communications interface 1120, a memory (memory array) 1130 and a bus 1140, wherein the processor 1110, the communications interface 1120 and the memory 1130 are intercommunicated through the bus 1140.

The communication interface 1120 is configured to communicate with a network element, wherein the network element includes, for example, a virtual machine management center, a shared storage or the like.

The processor 1110 is configured to execute programs. The processor 1110 may be a Central Processing Unit (CPU), an Application Specific Integrated Circuit (ASIC), or one or more integrated circuits configured to implement the embodiments of the present disclosure.

The memory 1130 is configured to store files. The memory 1130 may include a high-speed RAM memory, or may also include a non-volatile memory, for example, at least one disk memory. The memory 1130 may also be a memory array. The memory 1130 may also be divided into blocks, and the blocks may be combined under certain rules to form a virtual volume.

In one possible implementation, the programs may be program codes containing computer operation instructions. The programs may be specifically configured to execute the following steps of:

receiving an encrypted remote control instruction sent by a server through a pre-established encrypted network connection with the server, the remote control instruction being sent to the server by a user terminal;

decrypting the received encrypted remote control instruction and successively verifying the validity, legality and rationality of the decrypted remote control instruction;

executing the remote control instruction when all the validity, legality and rationality pass the verification; and

sending an instruction execution result to the server through the encrypted network connection after the remote control instruction has been executed.

In one possible implementation, before receiving an encrypted remote control instruction sent by a server through a pre-established encrypted network connection with the server, the following steps are further included: connecting to a server through a mobile communication network; and, establishing an encrypted network connection with the server through encryption security authentication and key updating.

In one possible implementation, before receiving an encrypted remote control instruction sent by a server through a pre-established encrypted network connection with the server, the following steps are further included: connecting to a server through a Virtual Private Network (VPN), and establishing an encrypted private network connection with the server.

In one possible implementation, decrypting the received encrypted remote control instruction and successively verifying the validity, legality and rationality of the encrypted remote control instruction include: decrypting the received encrypted remote control instruction, verifying the validity of the remote control instruction to check whether the remote control instruction is sent to this vehicle or not, indicating that the validity passes the verification if the remote control instruction is sent to this vehicle, and indicating that the validity does not pass the verification if the remote control instruction is not sent to this vehicle; verifying the legality of the remote control instruction to determine whether the remote control instruction belongs to an instruction white-list or not, indicating that the legality passes the verification if the remote control instruction belongs to the instruction white-list, and indicating that the legality does not pass the verification if the remote control instruction does not belong to the instruction white-list; and, verifying the rationality of the remote control instruction to determine whether content of the remote control instruction meets a preset rational execution condition or not, indicating that the rationality passes the verification if the content of the remote control instruction meets the preset rational execution condition, and indicating that the rationality does not pass the verification if the content of the remote control instruction does not meet the preset rational execution condition.

In one possible implementation, the executing the remote control instruction when all the validity, legality and rationality pass the verification includes: determining, according to the content of the remote control instruction, whether the remote control instruction is executed by the vehicle-mounted remote control electronic device or a vehicle intelligent operating system; directly executing the remote control instruction when the remote control instruction is executed by the vehicle-mounted remote control electronic device; and, awakening the vehicle intelligent operating system to execute the remote control instruction when the remote control instruction is executed by the vehicle intelligent operating system.

It should be understood by those skilled in the art that the embodiments of the present disclosure may be provided as a method, a system or a computer program product. Therefore, the present disclosure may be in form of a hardware embodiment, a software embodiment, or an embodiment of combination of software and hardware. Moreover, the present disclosure may also be in form of a computer program product implemented on one or more computer readable storage media (includes but is not limited to a disk memory, an optical memory and the like) containing computer executable program codes.

The present disclosure is described with reference to the flowchart and/or block diagram of the method, device (system) and computer program product. It should be understood that each flow and/or block of the flowcharts and/or the block diagrams as well as a combination of flows and/or blocks of the flowcharts and/or the block diagrams may be implemented by computer program instructions. These computer program instructions may be provided to a general-purpose computer, a dedicated computer, an embedded processor or processors of other programmable data processing devices to generate a machine, such that a device configured to implement functions of one or more flows in the flowchart and/or one or more blocks in the block diagrams may be generated by the instructions executed on a computer or processors of other programmable data processing devices.

These computer program instructions may also be stored in a computer readable memory which can direct the computer or other programmable data processing devices to operate in a specific mode, so as to enable the instructions stored in the computer readable memory to generate a manufacture product containing an instruction device. The instruction device can implement the function designated in one or more flows in the flowchart and/or one or more blocks in the block diagrams.

These computer program instructions may also be loaded in a computer or other programmable data processing devices, so as to perform a series of operation steps on the computer or other programmable data processing devices to generate processing implemented by the computer, thus instructions executed on the computer or other programmable devices can provide steps for implementing functions designated in one flow or more flows in the flowcharts and/or one or more blocks in the block diagrams.

The foregoing descriptions of the specific exemplary embodiments of the present disclosure are for purpose of explanation and illustration. These descriptions are not intended to limit the present disclosure as the disclosed precise form, and apparently, various alterations and variations can be made according to the above teaching. Selection and description for the exemplary embodiments aim at the specific principle explaining the present disclosure and practical applications thereof, such that those skilled in the art can realize and utilize various different exemplary embodiments in the present disclosure and various different selections and alterations. The scope of the present disclosure shall be limited by the appended claims and equivalent forms thereof.

The above-described device embodiments are merely exemplary, wherein units described as separated components may be or may not be separated physically, and components displayed as the units may be or may not be physical units, namely, may be located on the same position, or may be distributed on multiple network units. Part or all of modules may be selected to realize the purpose of the solutions of the embodiment according to practical needs. Those skilled in the art can understand and implement without paying creative labor.

What is claimed is:

1. A method for vehicle remote control, which is applied to a terminal, comprising:
receiving an encrypted remote control instruction sent by a server through a pre-established encrypted network connection with the server, the remote control instruction being sent to the server by a user terminal;
decrypting the received encrypted remote control instruction, and successively verifying the validity, legality and rationality of the decrypted remote control instruction;
executing the remote control instruction when all the validity, legality and rationality pass the verification; and
sending an instruction execution result to the server through the encrypted network connection after the remote control instruction has been executed.

2. The method according to claim 1, wherein before the receiving an encrypted remote control instruction sent by a server through a pre-established encrypted network connection with the server, the said method further comprises:
connecting to a server through a mobile communication network; and
establishing an encrypted network connection with the server through encryption security authentication and key updating.

3. The method according to claim 1, wherein before the receiving an encrypted remote control instruction sent by a server through a pre-established encrypted network connection with the server, the said method further comprises: connecting to a server through a Virtual Private Network VPN, and establishing an encrypted private network connection with the server.

4. The method according to claim 1, wherein the decrypting the received encrypted remote control instruction and successively verifying the validity, legality and rationality of the encrypted remote control instruction comprises:
decrypting the received encrypted remote control instruction, verifying the validity of the remote control instruction to check whether the remote control instruction is sent to the vehicle or not, indicating that the validity passes the verification if the remote control instruction is sent to this vehicle, and indicating that the validity does not pass the verification if the remote control instruction is not sent to this vehicle;
verifying the legality of the remote control instruction to determine whether the remote control instruction belongs to an instruction white-list or not, indicating that the legality passes the verification if the remote control instruction belongs to the instruction white-list, and indicating that the legality does not pass the verification if the remote control instruction does not belong to the instruction white-list; and
verifying the rationality of the remote control instruction to determine whether content of the remote control instruction meets a preset rational execution condition or not, indicating that the rationality passes the verification if the content of the remote control instruction meets the preset rational execution condition, and indicating that the rationality does not pass the verification if the content of the remote control instruction does not meet the preset rational execution condition.

5. The method according to claim 1, wherein executing the remote control instruction when all the validity, legality and rationality pass the verification comprises:
determining, according to the content of the remote control instruction, whether the remote control instruction is executed by the vehicle-mounted remote control electronic device or a vehicle intelligent operating system;
directly executing the remote control instruction when the remote control instruction is executed by the vehicle-mounted remote control electronic device; and
awakening the vehicle intelligent operating system to execute the remote control instruction when the remote control instruction is executed by the vehicle intelligent operating system.

6. An electronic device for vehicle-mounted remote control, comprising:
at least one processor; and
a memory communicably connected with the at least one processor for storing instructions executable by the at least one processor, wherein execution of the instructions by the at least one processor causes the at least one processor to:
receive an encrypted remote control instruction sent by a server through a pre-established encrypted network connection with the server, the remote control instruction being sent to the server by a user terminal;
decrypt the received encrypted remote control instruction, and successively verify the validity, legality and rationality of the decrypted remote control instruction;
execute the remote control instruction when all the validity, legality and rationality pass the verification; and
send an instruction execution result to the server through the encrypted network connection after the remote control instruction has been executed.

7. The device according to claim 6, wherein before receiving an encrypted remote control instruction sent by a server through a pre-established encrypted network connection with the server, the processor executes:
connecting to a server through a mobile communication network; and
establishing an encrypted network connection with the server through encryption security authentication and key updating.

8. The electronic device according to claim 6, wherein before receiving an encrypted remote control instruction sent by a server through a pre-established encrypted network connection with the server, the processor executes:
connecting to a server through a Virtual Private Network (VPN) and establishing an encrypted private network connection with the server.

9. The electronic device according to claim 6, wherein the processor executes:
decrypting the received encrypted remote control instruction, verifying the validity of the remote control instruction to check whether the remote control instruction is sent to this vehicle or not, indicating that the validity passes the verification if the remote control instruction is sent to this vehicle, and indicating that the validity does not pass the verification if the remote control instruction is not sent to this vehicle;
verifying the legality of the remote control instruction to determine whether the remote control instruction belongs to an instruction white-list or not, indicating that the legality passes the verification if the remote control instruction belongs to the instruction white-list, and indicating that the legality does not pass the verification if the remote control instruction does not belong to the instruction white-list; and
verifying the rationality of the remote control instruction to determine whether content of the remote control instruction meets a preset rational execution condition or not, indicating that the rationality passes the verification if the content of the remote control instruction meets the preset rational execution condition, and indicating that the rationality does not pass the verification if the content of the remote control instruction does not meet the preset rational execution condition.

10. The electronic device according to claim 6, wherein the processor executes:
determining, according to the content of the remote control instruction, whether the remote control instruction is executed by the vehicle-mounted remote control electronic device or a vehicle-mounted intelligent operating system;
directly executing the remote control instruction when the remote control instruction is executed by the vehicle-mounted remote control electronic device; and
awakening the vehicle intelligent operating system to execute the remote control instruction when the remote control instruction is executed by the vehicle intelligent operating system.

11. A non-transitory computer-readable storage medium storing executable instructions that, when executed by an electronic device, cause the electronic device to:
receive an encrypted remote control instruction sent by a server through a pre-established encrypted network connection with the server, the remote control instruction being sent to the server by a user terminal;
decrypt the received encrypted remote control instruction, and successively verify the validity, legality and rationality of the decrypted remote control instruction;
execute the remote control instruction when all the validity, legality and rationality pass the verification; and
send a result of instruction execution to the server through the encrypted network connection after the remote control instruction has been executed.

12. The non-transitory computer-readable storage medium according to claim 11, wherein when the executable instructions is executed by an electronic device, cause the electronic device to: before receiving an encrypted remote control instruction sent by a server through a pre-established encrypted network connection with the server, connect to a server through a mobile communication network; and
establish an encrypted network connection with the server through encryption security authentication and key updating.

13. The non-transitory computer-readable storage medium according to claim 11, wherein when the executable instructions is executed by an electronic device, cause the electronic device to: before receiving an encrypted remote control instruction sent by a server through a pre-established encrypted network connection with the server, connect to a server through a Virtual Private Network (VPN), and establish an encrypted private network connection with the server.

14. The non-transitory computer-readable storage medium according to claim 11, wherein when the executable instructions is executed by an electronic device, cause the electronic device to:
decrypt the received encrypted remote control instruction, verify the validity of the remote control instruction to check whether the remote control instruction is sent to this vehicle or not, indicate that the validity passes the verification if the remote control instruction is sent to this vehicle, and indicate that the validity does not pass the verification if the remote control instruction is not sent to this vehicle;
verify the legality of the remote control instruction to determine whether the remote control instruction belongs to an instruction white-list or not, indicate that the legality passes the verification if the remote control instruction belongs to the instruction white-list, and indicate that the legality does not pass the verification if the remote control instruction does not belong to the instruction white-list; and
verify the rationality of the remote control instruction to determine whether content of the remote control instruction meets a preset rational execution condition or not, indicate that the rationality passes the verification if the content of the remote control instruction meets the preset rational execution condition, and indicate that the rationality does not pass the verification if the content of the remote control instruction does not meet the preset rational execution condition.

15. The non-transitory computer-readable storage medium according to claim 11, when the executable instructions is executed by an electronic device, cause the electronic device to:
determine, according to the content of the remote control instruction, whether the remote control instruction is executed by the vehicle-mounted remote control electronic device or a vehicle-mounted intelligent operating system;
directly execute the remote control instruction when the remote control instruction is executed by the vehicle-mounted remote control electronic device; and
awaken the vehicle intelligent operating system to execute the remote control instruction when the remote control instruction is executed by the vehicle intelligent operating system.
